(19) United States
(12) Patent Application Publication
(10) Pub. No.: US 2011/0307939 A1
(43) Pub. Date: Dec. 15, 2011

(54) ACCOUNT ISSUANCE SYSTEM, ACCOUNT SERVER, SERVICE SERVER, AND ACCOUNT ISSUANCE METHOD

(76) Inventors: Aya Okashita, Tokyo (JP); Joao Girao, Heidelberg (DE)

(21) Appl. No.: 13/147,974

(22) PCT Filed: Feb. 4, 2010
(86) PCT No.: PCT/JP2010/051591

§ 371 Date: Aug. 4, 2011

(30) Foreign Application Priority Data
Feb. 9, 2009 (JP) 2009-027270

(51) Int. Cl. H04L 9/32

(52) U.S. Cl. 726/3

(57) ABSTRACT

Provided is an account issuance system that can open an account owner in a service server to the outside without revealing personal information. Terminal 1 transmits joint identification information set by a user to account server 3. After having received the joint identification information from terminal 1, account server 3 generates a public ID to enable a third party different from the user to identify the user by using the joint identification information and a unique ID, and transmits the public ID to user terminal 1. After having received the public ID, user terminal 1 transmits the public ID to service server 2. After having received the public ID from user terminal 1, service server 2 sets the public ID so that the public ID can be opened to the outside.

### TECHNICAL FIELD

The present invention relates to an account issuance system, an account server, a service server, and an account issuance method.

### BACKGROUND ART

When a user receives various services provided through the internet, it is often the case that a service server providing the services issues an account to identify the user (refer to Nonpatent Literature 1).

A plurality of service servers, when independently issuing accounts, may issue identical accounts to different users. Thus, when the users are allowed to set accounts, if a first user's account is public, the second user different from the first user can intentionally set the same account to receive other services. This enables the second user to pretend to be the first user.

To determine whether identical accounts issued by different service servers have been issued to the same user, there is available a method for revealing an account by linking it with identification information (e.g., ID) identifying an individual.

### CITATION LIST

### Nonpatent Literature

Nonpatent Literature 1: pp. 1 to 6, “Proposal of Authentication Infrastructure for Simultaneously Achieving Privacy Protection and Single Personal ID” by Daisuke Yoshii, Kota Abe, Hayato Ishibashi, and Toshio Matsuura, Research Report of Information Processing Society of Japan, 2008-CSWS-40, Mar. 6, 2008.

### SUMMARY OF INVENTION

### Problem to be Solved by the Invention

However, revealing the identification information causes a problem of leakage of personal information contained in the identification information.

An object of the present invention is to provide an account issuance system, an account server, a service server, and an account issuance method that can solve the abovementioned problem.

### Solution to Problem

An account issuance system according to the present invention includes: a terminal used by a user; a service server that provides services to the user via the terminal; and an account server that issues an account used by the service sever to identify the user. In this case, the terminal transmits joint identification information of the user set by the user to the account server and, after having received a public ID used by a third party different from the user to identify the user from the account server, transfers the public ID to the service server. The account server stores a unique ID to uniquely identify the user, generates, after having received the joint identification information from the terminal, the public ID by using the joint identification information and the unique ID, and transmits the public ID to the terminal. The service server sets, after having received the public ID from the terminal, the public ID openable to the outside.

An account server according to the present invention, which issues an account used by a service server for providing services to a user of a terminal via the terminal to identify the user, includes: a storage unit that stores a unique ID to uniquely identify the user; a reception unit that receives joint identification information of the user set by the user from the terminal; and an ID generation unit that generates, by using the joint identification information received by the reception unit and the unique ID stored by the storage unit, a public ID used by a third party different from the user to identify the user, and transmits the public ID to the terminal.

A service server according to the present invention, which provides services to a user via a terminal used by the user, includes: a user registration reception unit that receives a public ID used by a third party different from the user to identify the user, and a specific ID used by the service server to identify the user from the terminal; an ID storage unit that stores the public ID received by the user registration reception unit; a temporary user registration notification unit that adds, after the user registration reception unit has received the specific ID, the specific ID to a temporary user registration notification indicating that the user has temporarily been registered, and that transmits the notification to a contact device configured to transfer data having the specific ID to the terminal; and a user registration unit that sets, after having received a confirmation notification indicating that the temporary user registration notification has been confirmed from the terminal, the public ID stored by the ID storage unit openable to the outside.

The present invention provides a account issuance method based on an account issuance system according to the present invention, the account issuance system including a terminal used by a user, a service server that provides services to the user via the terminal, an account server that issues an account used by the service sever to identify the user, and the account server being configured to store a unique ID to uniquely identify the user. The method includes: transmitting joint identification information of the user set by the user to the account server by the terminal; generating, by the account server, after having received the joint identification information from the terminal, a public ID used by a third party, different from the user, to identify the user by using the joint identification information and the unique ID, and transmitting the public ID to the terminal; transmitting, after having received the public ID from the account server, the public ID to the service server by the terminal; and setting, after having received the public ID from the terminal, the public ID openable to the outside by the service server.

The present invention provides a first program for causing an account server to execute a process, the account server being configured to issue an account used by a service server for providing services to a user of a terminal via the terminal to identify the user. The process includes the steps of: storing a unique ID to uniquely identify the user; receiving joint identification information of the user set by the user from the terminal; generating, by using the received joint identification information and the stored unique ID, a public ID used by a third party different from the user to identify the user; and transmitting the generated public ID to the terminal.

The present invention provides a program for causing a service server to execute a process, the service server being configured to provide services to a user via a terminal used by the user. The process includes the steps of: receiving a public ID used by a third party different from the user to identify the user, and a specific ID used by the service server to identify the user from the terminal; storing the received public ID; adding, after the specific ID has been received, the specific ID to a temporary user registration notification indicating that the user has temporarily been registered, and transmitting the notification to a contact device configured to transfer data having the specific ID to the terminal; and setting, after a confirmation notification indicating that the temporary user registration notification has been confirmed has been received from the terminal, the stored public ID openable to the outside.

### Effects of the Invention

According to the present invention, an account owner in the service server can be opened to the outside without revealing personal information.

### BRIEF DESCRIPTION OF DRAWINGS

FIG. 1 is a diagram showing an account issuance system according to an exemplary embodiment of the present invention.

FIG. 2 is a diagram showing an example of a user screen.

FIG. 3 is a diagram showing an example of user information.

FIG. 4 is a diagram showing an example of electronic mail.

FIG. 5 is a diagram showing an example of mail address setting information.

FIG. 6 is a diagram showing an example of a user registration screen.

FIG. 7 is a diagram showing an example of a temporary user registration notification.

FIG. 8 is block diagram showing a configuration of a user terminal.

FIG. 9 is a diagram showing a first example of information in a storage unit of the user terminal.

FIG. 10 is a diagram showing a second example of information in the storage unit of the user terminal.

FIG. 11 is a block diagram showing a configuration of a service server.

FIG. 12 is a diagram showing an example of a user registration completion notification screen.

FIG. 13 is a diagram showing an example of an outside-opening screen including user public information and a public ID.

FIG. 14 is a diagram showing an example of a configuration of an account server.

FIG. 15 is a diagram showing an example of a configuration of a user contact device.

FIG. 16 is an explanatory sequential diagram showing an operation of the account issuance system.

FIG. 17 is a diagram showing an account issuance system according to another exemplary embodiment of the present invention.

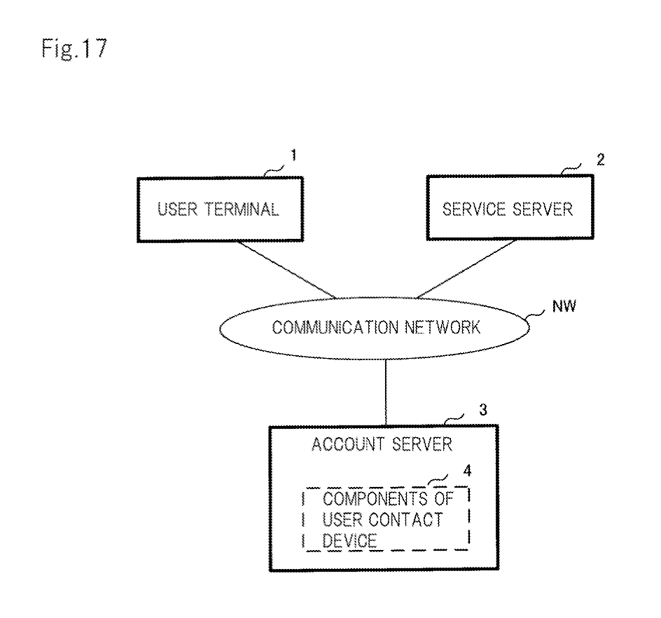

### DESCRIPTION OF EXEMPLARY EMBODIMENTS

Hereinafter, exemplary embodiments of the present invention are described with reference to the drawings.

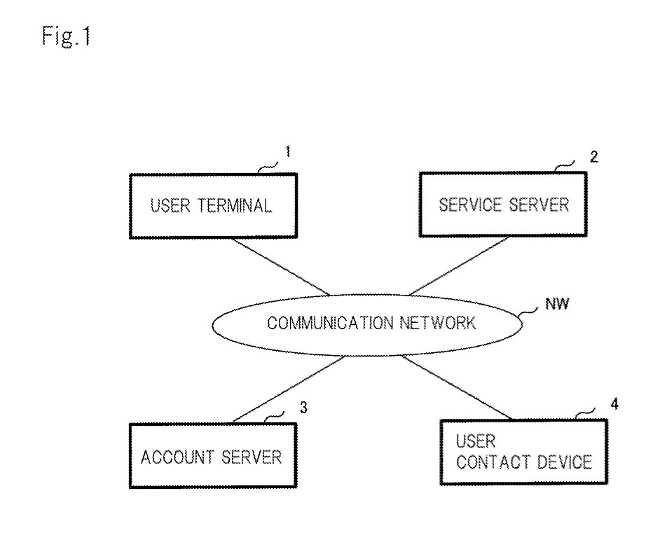

First, referring to FIG. 1, a configuration of an account issuance system according to an exemplary embodiment is described.

As shown in FIG. 1, the account issuance system includes user terminal 1 (hereinafter, simply “terminal 1”), service server 2, account server 3, and user contact device 4 (hereinafter, simply “contact device 4”). Terminal 1, service server 2, account server 3, and contact device 4 can be interconnected via a communication network NW such as the Internet.

Terminal 1 is used by a user. Terminal 1 has a function of using services provided from service server 2 and a function of transmitting or receiving electronic mail. For example, terminal 1 is a PC (personal computer) or a cellular phone.

Service server 2 provides services to the user of terminal 1 via the communication network NW and terminal 1. The service server is, for example, a web server that stores service sites present in the Internet.

Account server 3 issues an account of service sever 2 to the user of terminal 1. The account is used for identifying the user when service server 2 provides services to the user.

Contact device 4 can transfer data from service server 2 and account server 3 to terminal 1. Contact device 4 is, for example, an electronic mail server that transfers electronic mail to its address.

Terminal 1, service server 2, account server 3, and contact device 4 cooperate and perform processing below in association.

Terminal 1 stores a user ID provided beforehand to the user by account server 3. Account server 3 stores the user ID and a unique ID provided beforehand to the user by account server 3 in correspondence.

The user ID is, when account server 3 authenticates the user, identification information to identity the user. In the exemplary embodiment, the user ID is “test0001”.

The unique ID is unique identification information used by account server 3 to uniquely identify the user. In other words, the unique ID is high identity verification information in which only one unique ID is provided to one user to prevent overlapping among a plurality of users. To protect user's privacy, the unique ID is hidden from service server 2.

In the exemplary embodiment, the unique ID is an electronic mail address (test0001@mailserver_domain.jp) to designate terminal 1 as an address.

Account server 3 transmits the unique ID to contact device 4. Contact device 4 receives the unique ID from account server 3, and stores the unique ID. After having received electronic mail having the unique ID stored in the device and attached as an address to the mail from service server 2 or account server 3, contact device 4 transfers the electronic mail to terminal 1.

Terminal 1 requests account server 3 to issue a specific ID or a public ID. The specific ID is identification information used by service server 2 to specifically identify the user. The public ID is identification information used by a third party different from the user to identify the user, and is revealed so that the third party can identify the user.

When requesting issuance of the specific ID and the public ID, in the exemplary embodiment, terminal 1 first transmits an authentication request to authenticate the user and the user ID to account server 3.

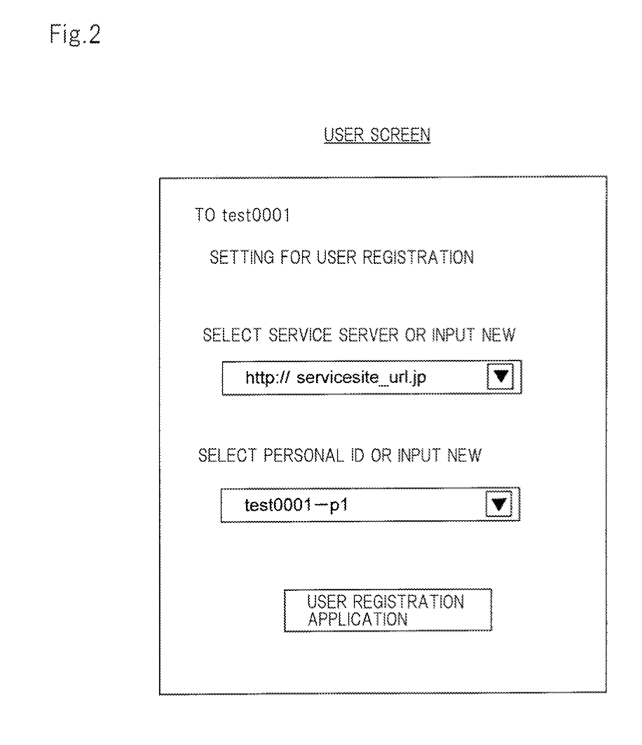

Account server 3 that has received the authentication request and the user ID from terminal 1 compares the user ID with the user ID stored therein. When the user IDs match each other, account server 3 transmits authentication success information indicating authentication success and screen information indicating a user screen to terminal 1. The user screen is, for example, a screen to prompt the user to execute user registration shown in FIG. 2.

Terminal 1 that has received the authentication success information and the screen information from account server 3 displays the user screen indicated by the screen information. The user then refers to the user screen to select or input a service ID and a personal ID. Terminal 1 receives the service ID and the personal ID from the user, and transmits an ID request for issuance of a specific ID or a public ID together with the service ID and the personal ID to account server 3.

The personal ID is user's own joint identification information set by the user. Even when the account issuance system includes a plurality of service servers 2, the personal ID is used by respective service servers 2 to cause the user to reveal the same public ID. In the exemplary embodiment, the personal ID is “test0001-p1”.

The service ID is identification information (e.g., URL (Uniform Resource Locater) to uniquely identify service server 2. In the exemplary embodiment, the service ID is a URL of service server 2 “http://servicesite_url.jp”.

After having received the ID request, the service ID, and the personal ID, account server 3 generates a specific ID and a public ID by using the service ID and the personal ID. More specifically, account server 3 generates the specific ID by using the service ID and the stored unique ID, and the public ID by using the personal ID and the stored unique ID.

Account server 3 further stores the specific ID and the public ID in a corresponding relationship to the user ID and the unique ED stored therein in correspondence.

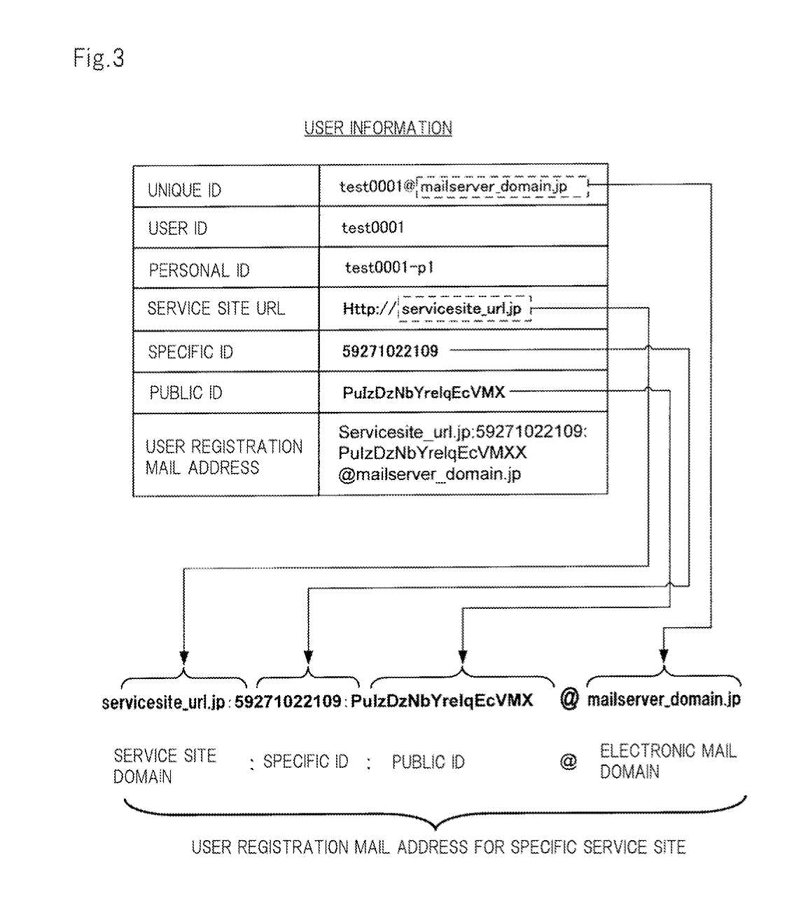

Account server 3 generates, based on the specific ID and the public ID, a user registration electronic mail address (hereinafter, simply “registration address”). Account server 3 further stores the registration address in a corresponding relationship to the user ID, the unique ID, the specific ID, and the public ID stored in correspondence. User information is, for example, as shown in FIG. 3.

The registration address is another name contact information to designate terminal 1 defined by another name different from the unique ID as an address.

In the exemplary embodiment, as shown in FIG. 3, account server 3 generates information containing a part of the service ID of service server 2 (servicesite_url._jp), a specific ID (59271022109), and a public ID (PuIzDzNbYrelqEcVMX) as a registration address.

Account server 3 transmits the specific ID, the public ID, and the registration address that have been generated to terminal 1, and the registration address and the unique ID to contact device 4.

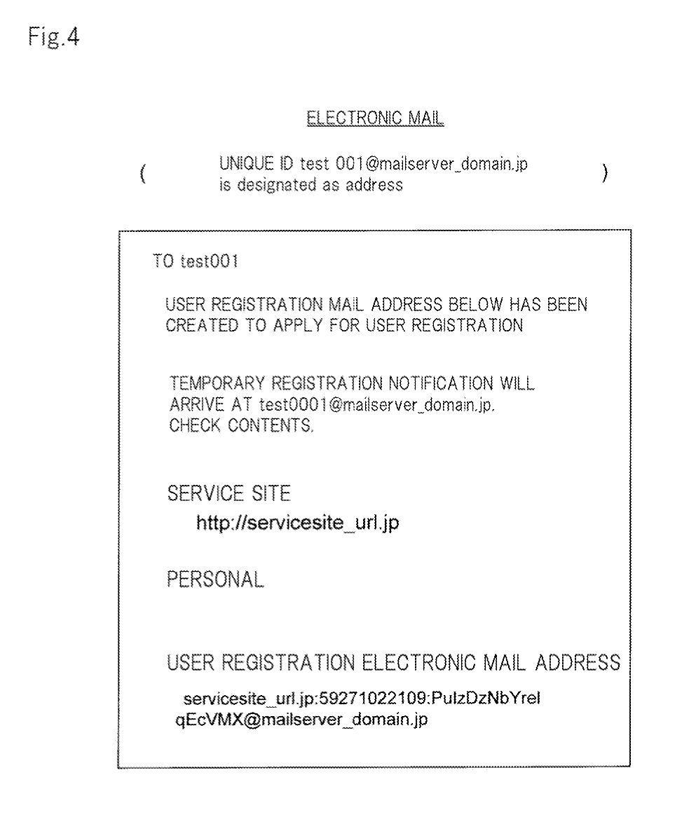

The registration address contains the specific ID and the public ID, and hence account server 3 can transmit only the registration address to terminal 1. Account server 3 can directly transmit the specific ID, the public ID, and the registration address to terminal 1 or indirectly via another device such as contact device 4. In the exemplary embodiment, to transmit the specific ID, the public ID, and the registration address to terminal 1, account server 3 transmits electronic mail shown in FIG. 4 to contact device 4 by designating the unique ID of terminal 1 as an address. Contact device 4 receives the electronic mail from account server 3 to transfer it to terminal 1.

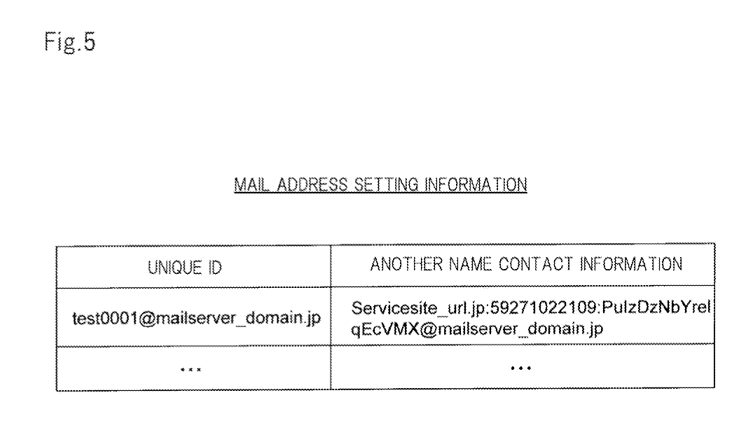

After having received the registration address and the unique ID from account server 3, contact device 4 stores, in correspondence, the registration address and the unique ID as mail address setting information shown in FIG. 5. This enables contact device 4 to transfer, after having received electronic mail addressed to the registration address, the electronic mail to transfer 1.

Terminal 1 that has received the registration address from account server 3 transmits the registration address and a registration request to register the user to service server 2.

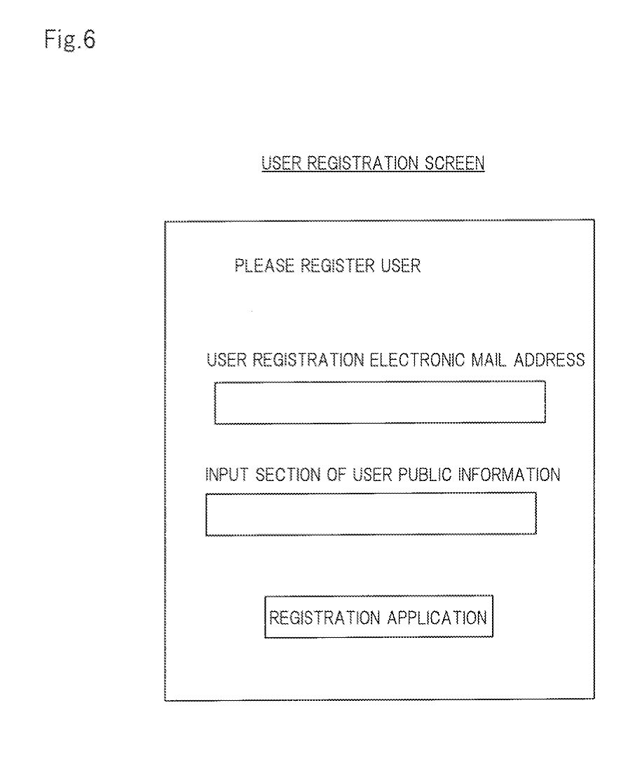

Terminal 1 can display a user registration screen shown in FIG. 6 to request the service server 2 to register the user, and transmit a registration address that the user inputs by referring to the user registration screen. In the exemplary embodiment, terminal 1 transmits user public information regarding the user together with the registration address to service server 2. The user public information is information to be revealed (e.g., user name), which contains no personal information to be hidden from the third party.

After having received the registration address and the registration request from terminal 1, service server 2 determines whether or not the specific ID and the public ID contained in the registration address have been altered, in other words, whether or not the specific ID and the public ID are legitimate.

In the exemplary embodiment, service server 2 analyzes a domain in the registration address to determine whether the domain matches a domain (mailserver_domain.jp) to which legitimate contact device 4 belongs. When the domains match each other, service server 2 determines that the registration address is an electronic mail address issued from legitimate contact device 4, thereby determining that the specific ID and the public ID contained in the registration address are legitimate.

After having determined that the specific ID and the public ID are legitimate, service server 2 stores the specific ID and the public ID contained in the registration address in correspondence. Service server 2 then adds the registration address as an address to a temporary user registration notification indicating that the user has temporarily been registered, and transmits the notification to contact device 4. Contact device 4 that has received the temporary user registration notification from service server 2 transfers it to terminal 1 designated by a unique ID storing the temporary user registration notification.

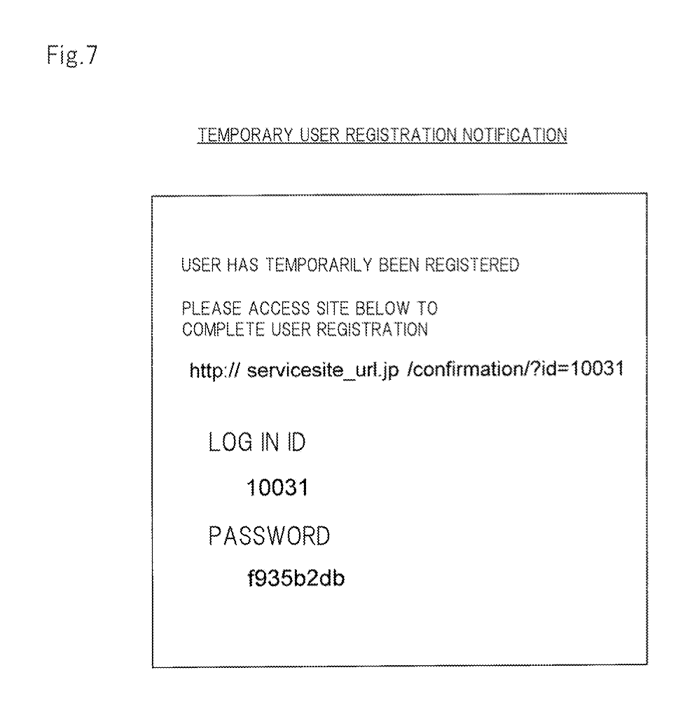

As shown in FIG. 7, the temporary user registration notification can contain a log-in ID and a password used for receiving services from service server 2. The temporary user registration notification can contain a URL that becomes a terminal connection destination to notify service server 2 of a confirmation notification indicating that the user has confirmed the temporary user registration notification.

Service server 2 that has received the confirmation notification from terminal 1 registers the user. To register the user, service server 2 sets the public ID and the user public information of the user having the public ID added thereto to be openable to the outside. After the user registration, service server 2 can provide services to the user.

Next, configurations of the devices included in the account issuance system are described.

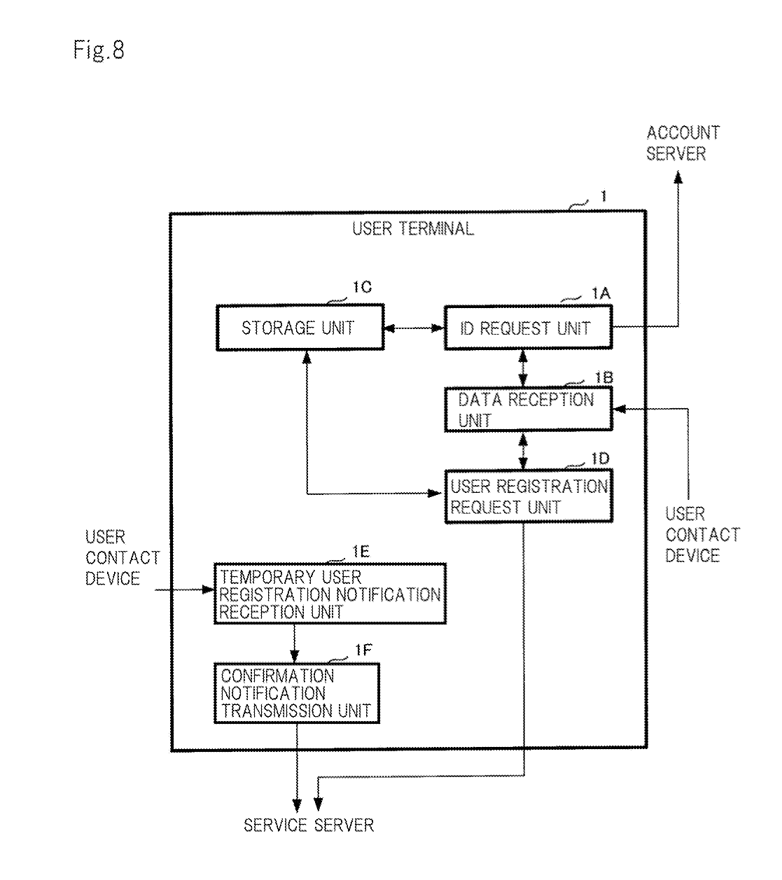

First, the configuration of terminal 1 is described in detail. FIG. 8 is a block diagram showing the configuration of terminal 1.

As shown in FIG. 8, terminal 1 includes ID request unit 1A, data reception unit 1B, storage unit 1C, user registration request unit 1D, temporary user registration notification reception unit 1E, and confirmation notification transmission unit 1F.

ID request unit 1A requests account server 3 to issue an ID (specific ID and public ID). More specifically, ID request unit 1A transmits an authentication request for performing user authentication and a user ID to account sever 3.

ID request unit 1A receives authentication success information and screen information from account server 3.

ID request unit 1A receives a service ID and a personal ID that the user has selected by referring to a user screen indicated by the screen information. ID request unit 1A transmits the service ID and the personal ID that have been received, and the ID request to account server 3. In the exemplary embodiment, the ID request is information requesting issuance of a public ID, a specific ID, and a registration address.

Data reception unit 1B transmits and receives various data to and from account server 3 and contact device 4.

For example, data reception unit 1B receives the electronic mail shown in FIG. 4, which has originally been transmitted from account server 3 and which is then transferred from contact device 4. Data reception unit 1B writes the registration address contained in the electronic mail in storage unit 1C.

Storage unit 1C stores various data. For example, storage unit 1C stores the personal ID that ID request unit 1A has received from the user. Storage unit 1C stores the unique ID that account server 3 has provided to the user.

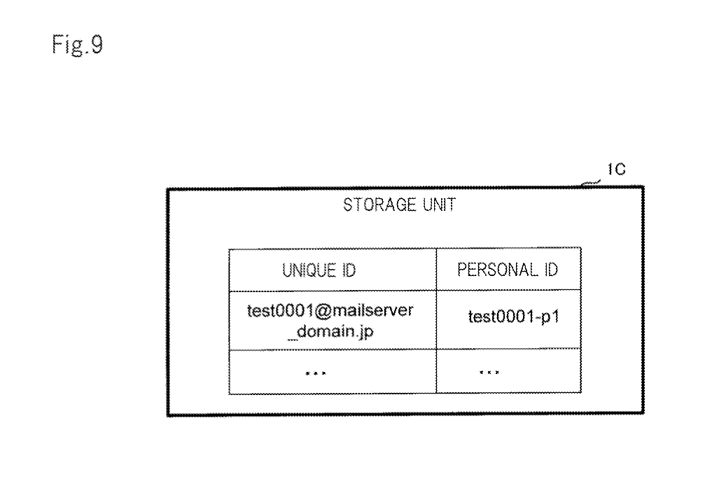

Before account server 3 issues the public ID, the specific ID, and the registration address, as shown in FIG. 9, storage unit 1C will have already stored the unique ID and the personal ID.

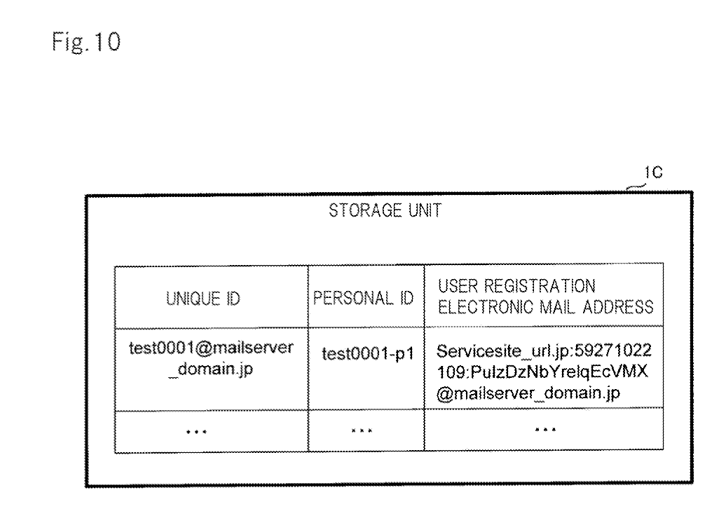

Storage unit 1C stores the registration address contained in the electronic mail received by data reception unit 1B. In this case, as shown in FIG. 10, storage unit 1C has stored the registration address in addition to the unique ID and the personal ID.

User registration request unit 1D requests service server to register the user. More specifically, user registration unit 1D reads the registration address from storage unit 1C, and transmits the registration address and the user registration request to service server 2. In the exemplary embodiment, user registration request unit 1D transmits the same registration address as that selected by the user referring to the user registration screen.

In the exemplary embodiment, user registration request unit 1D transmits openable user public information regarding the user of terminal 1 together with the registration address to service server 2.

Temporary user registration notification reception unit 1E receives a temporary user registration notification transferred from contact device 4, which has originally been transmitted from service server 2.

Confirmation notification transmission unit 1F transmits a confirmation notification indicating that the user has confirmed the temporary user registration notification received by temporary user registration notification reception unit 1E to service server 2.

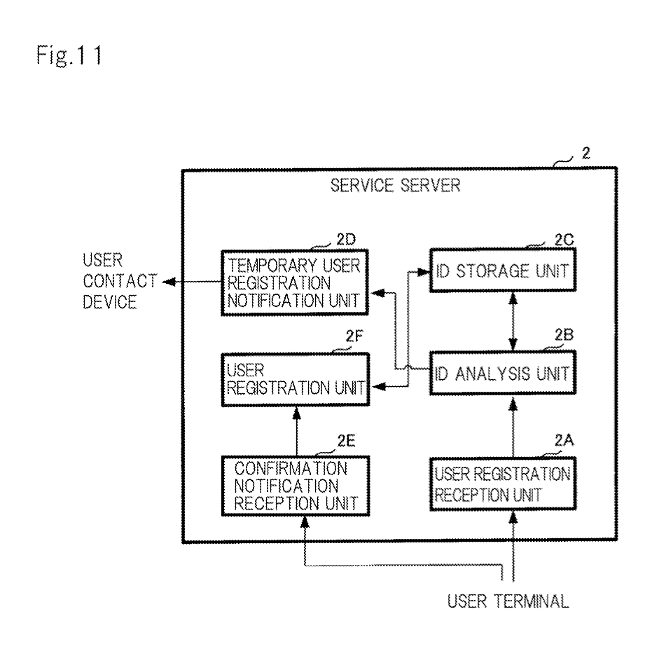

Next, the configuration of service server 2 is described in detail. FIG. 11 is a block diagram showing the configuration of service server 2.

As shown in FIG. 11, service server 2 includes user registration reception unit 2A, ID analysis unit 2B, ID storage unit 2C, temporary user registration notification unit 2D (hereinafter, simply “temporary notification unit 2D”), confirmation notification reception unit 2E, and user registration unit 2F.

After having received the user registration address, the user public information, and the user registration request from terminal 1, user registration reception unit 2A writes the user registration address and the user public information in ID storage unit 2C in correspondence.

ID analysis unit 2B determines whether or not the specific ID and the public ID contained in the registration address received by user registration reception unit 2A have been altered, in other words, whether or not the specific ID and the public ID are legitimate.

In the exemplary embodiment, ID analysis unit 2B analyzes a domain in the registration address to determine whether the registration address has been issued from legitimate contact device 4.

When the domain in the registration address matches the domain to which contact device 4 belongs, ID analysis unit 2B determines that the registration address has been issued from legitimate contact device 4. In this case, ID analysis unit 2B determines that the specific ID and the public ID in the registration address are legitimate, and extracts the specific ID and the public ID from the registration address.

ID analysis unit 2B writes the specific ID and the public ID in ID storage unit 2C in a corresponding relationship to the user registration address and the user public information, and notifies temporary notification unit 2D of the writing. When the specific ID and the public ID that have been extracted have been stored in ID storage unit 2C in correspondence, ID analysis unit 2B can notify terminal 1 of rejection of the user registration request.

After having notified of the writing, ID analysis unit 2B sets correspondence between a log-in ID and a password, and writes the log-in ID and the password in ID storage unit 2C in a corresponding relationship to the user public information, the registration address, the specific ID, and the public ID.

Temporary notification unit 2D that has been notified of the writing by ID analysis unit 2B transmits a temporary user registration notification indicating that the user has temporarily been registered to contact device 4 by designating the registration address of terminal 1 as an address.

In the exemplary embodiment, as shown in FIG. 7, the temporary user registration notification contains information indicating the log-in ID and the password used for receiving services from service server 2, and a URL becomes a terminal connection destination for providing a confirmation notification by the user.

Confirmation notification reception unit 2E receives the confirmation notification from terminal 1, and notifies user registration unit 2F of it.

After having received the confirmation notification from confirmation notification reception unit 2E, user registration unit 2F registers the user. In the exemplary embodiment, user registration unit 2F sets the public ID and the user public information corresponding to the public ID to be openable to the outside. User registration unit 2F then enables service server 2 to provide services to the user.

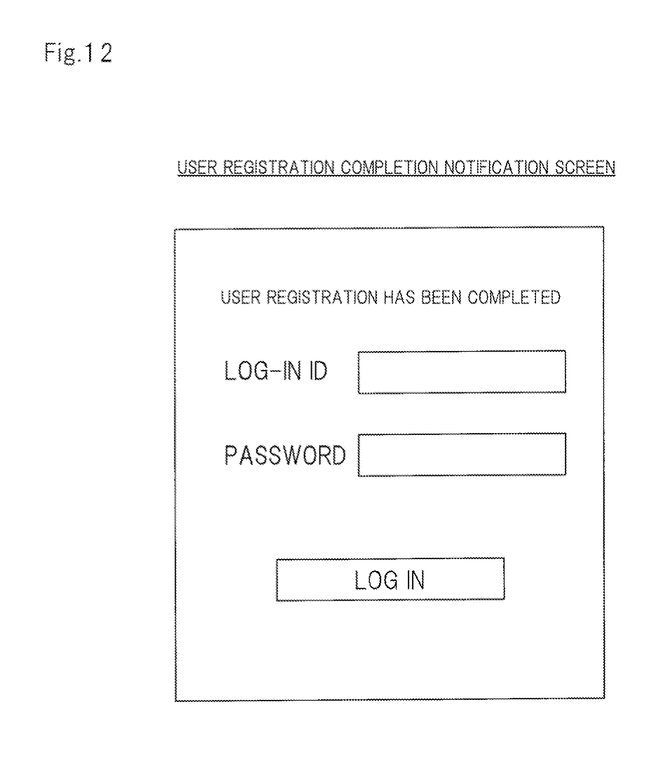

After having registered the user, user registration unit 2F transmits information on a user registration completion notification screen indicating that the user has been registered to terminal 1. The user registration completion notification screen is, for example, a screen shown in FIG. 12.

A case where the log-in ID and the password contained in the temporary user registration notification shown in FIG. 7 have been transmitted from terminal 1 is described. In this case, user registration unit 2F compares a set of the log-in ID and the password received from terminal 1 with a set of the log-in ID and the password corresponding to each other in ID storage unit 2C.

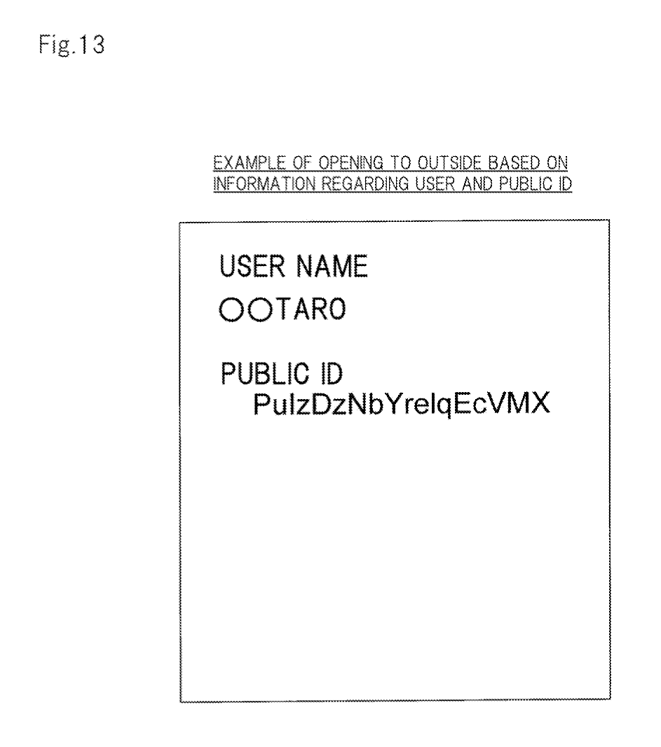

When the sets match each other, as shown in FIG. 13, user registration unit 2F displays the user public information and the public ID regarding the user of terminal 1.

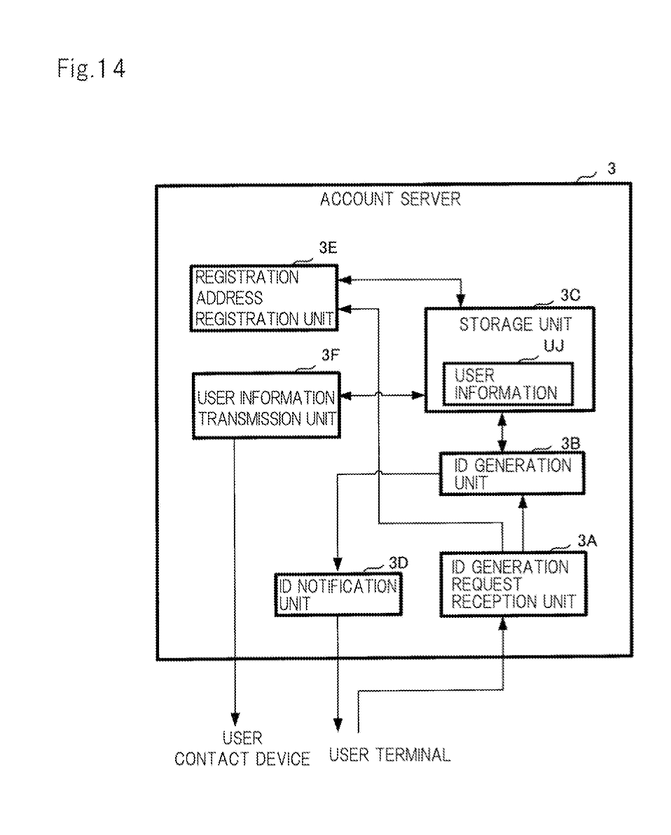

Next, the configuration of account server 3 is described in detail. FIG. 14 is a block diagram showing the configuration of account server 3.

As shown in FIG. 14, account server 3 includes ID generation request reception unit 3A, ID generation unit 3B, storage unit 3C, ID notification unit 3D, registration address generation unit 3E, and user information transmission unit 3F.

ID generation request reception unit 3A receives an authentication request and a user ID from terminal 1. ID generation request reception unit 3A compares the user ID received from terminal 1 with user ID in user information UJ stored in storage unit 3C.

When the user IDs match each other, ID generation request reception unit 3A transmits authentication success information and screen information indicating a user screen to terminal 1. Then, after having received a personal ID, a service ID, and an ID request from terminal 1, ID generation request reception unit 3A outputs the personal ID and the service ID to ID generation unit 3B.

After having received the personal ID and the service ID from ID generation request reception unit 3A, ID generation unit 3B generates a specific ID by using the service ID and a unique ID in storage unit 3C, and writes the specific ID in storage unit 3C.

In the exemplary embodiment, ID generation unit 3B generates the specific ID by applying a predetermined hash function to data containing a unique ID and a service ID (e.g., data obtained by coupling together unique ID and service ID).

ID generation unit 3B generates a public ID by using the personal ID received from ID generation request reception unit 3A and the unique ID in storage unit 1C, and stores the public ID in storage unit 3C.

In the exemplary embodiment, ID generation unit 3B generates the public ID by applying a predetermined hash function to data containing the personal ID and the unique ID.

When a decryption key is stored in service server 2, to enable service server 2 to decrypt the specific ID and the public ID by using the decryption key, ID generation unit 3B can encode the specific ID and the public ID by using an encoding key corresponding to the decryption key.

ID generation unit 3B can encode data obtained by adding the specific ID to the unique ID and the service ID and by coupling them with a random number.

ID generation unit 3B has a function of generating a user ID and a unique ID. The unique ID generated by ID generation unit 3B is transmitted to contact device 4 by user information transmission unit 3F.

As shown in FIG. 3, storage unit 3C can store the unique ID provided to the user of terminal 1, the user ID, the specific ID, the public ID, the personal ID, the service ID, and the registration ID in correspondence.

Storage unit 3C can store data such as a password, an electronic certificate, or personal information to identify the user in a corresponding relationship to the user ID. The user ID can be similar to the unique ID.

ID notification unit 3D notifies terminal 1 of the specific ID and the public ID generated by ID generation unit 3B. In this case, ID notification unit 3D couples together the specific ID and the public ID, encodes the specific ID and the public ID, or adds electronic signatures to the specific ID and the public ID to show legitimacy thereof.

In the exemplary embodiment, ID notification unit 3D transmits electronic mail containing the registration address, the specific ID, and the public ID shown in FIG. 4 to contact device 4 by designating the unique ID of terminal 1.

Registration address generation unit 3E generates a registration address based on the service ID that ID generation request reception unit 3A has received from terminal 1, and the unique ID in storage unit 3C, and writes the registration address in storage unit 3C.

User information transmission unit 3F transmits the registration address and the unique ID generated by registration address generation unit 3E to contact device 4.

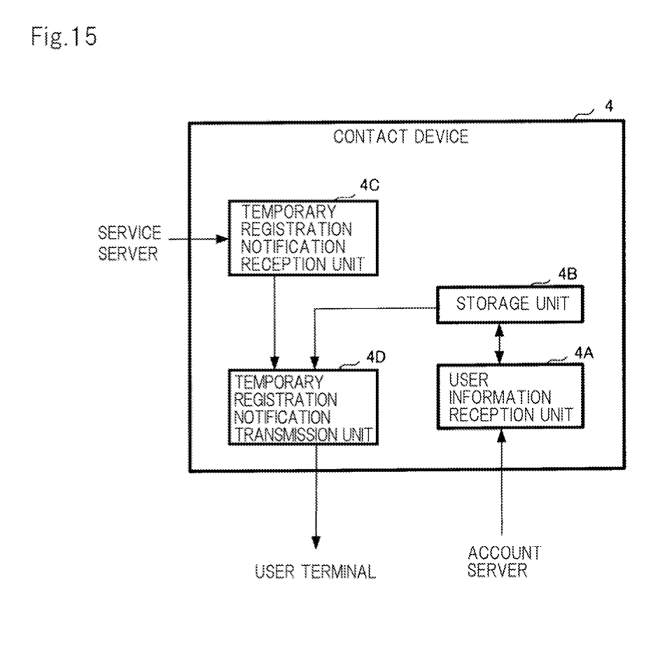

Next, the configuration of contact device 4 is described in detail. FIG. 15 is a block diagram showing the configuration of contact device 4.

As shown in FIG. 15, contact device 4 includes user information reception unit 4A, storage unit 4B, temporary registration notification reception unit 4C, and temporary registration notification transmission unit 4D.

User information reception unit 4A receives the unique ID and the registration address from account server 3.

User information reception unit 4A stores the unique ID and the registration address received from account server 3 in storage unit 4B in correspondence. Storage unit 4B accordingly stores the registration address and the unique ID in correspondence as in the case of the mail address setting information shown in FIG. 5.

Temporary registration notification reception unit 4C receives a temporary user registration notification containing the registration address of terminal 1 as an address from service server 2.

Temporary registration notification transmission unit 4D transmits the temporary user registration notification received by temporary registration notification reception unit 4C by designating the unique ID stored in storage unit 4B in a corresponding relationship to the registration address of terminal 1.

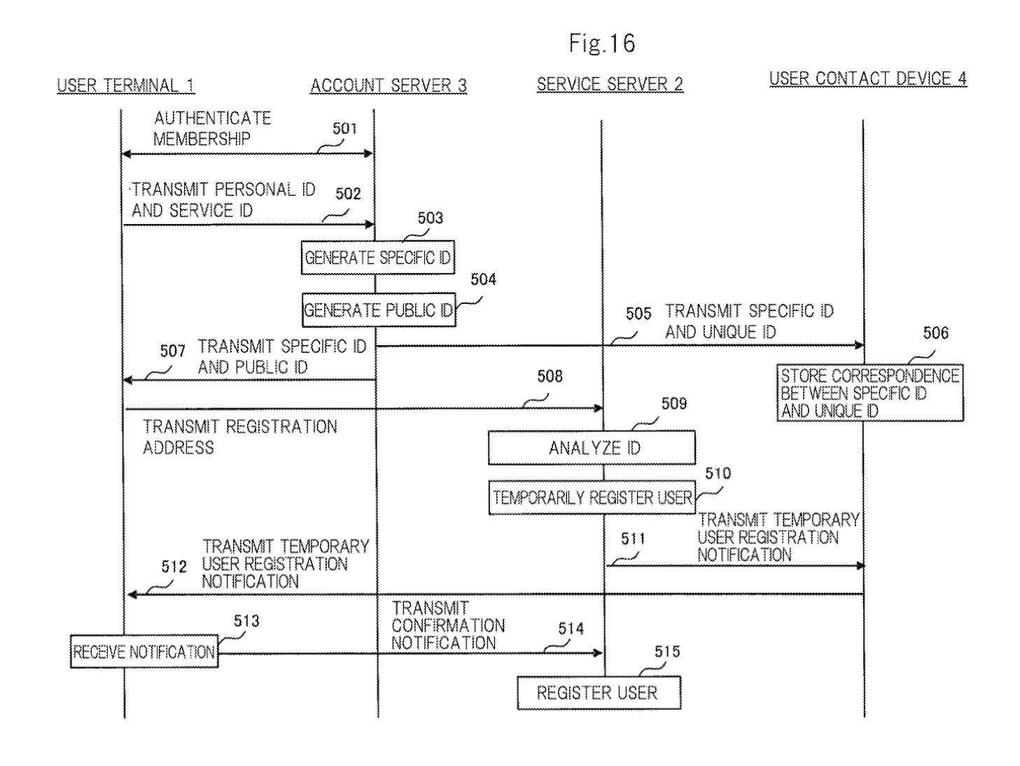

Next, an operation of the account issuance system is described. FIG. 16 is an explanatory sequential diagram showing an operation of the account issuance system to set user public information to be openable to the outside.

As shown in FIG. 16, first, in step 501, account server 3 authenticates a user by using a user ID received together with an authentication request from terminal 1. A case where authentication has been successful is described below.

In this case, in step 502, terminal 1 transmits a personal ID and a service ID to account server 3.

In step 503, account server 3 receives the personal ID and the service ID from terminal 1, and generates a specific ID by using the service ID and a unique ID stored in the account server. Account server 3 writes the generated specific ID in storage unit 3C.

Then, in step 504, account server 3 generates a public ID.

Subsequently, in step 505, account server 3 transmits a registration address and a unique ID of the user to contact device 4.

In step 506, contact device 4 that has received the registration address and the unique ID stores the registration address and the unique ID in correspondence.

In step 507, account server 3 transmits the specific ID and the public ID generated in steps 503 and 504, and the registration address to terminal 1.

In the exemplary embodiment, in step 507, account server 3 transmits, by designating a unique ID of terminal 1, electronic mail containing the specific ID, the public ID, and the registration address to terminal 1 via contact device 4. In this case, terminal 1 receives the electronic mail containing the specific ID, the public ID, and the registration address originally transmitted from account server 3 from contact device 4.

Subsequently, in step 508, terminal 1 transmits a registration address and user public information that the user has input by referring to the user registration screen to service server 2.

In step 509, service server 2 determines whether the specific ID and the public ID contained in the registration address from terminal 1 are legitimate.

When the specific ID and the public ID are legitimate, service server 2 extracts the specific ID and the public ID from the registration address.

In step 510, service server 2 temporarily stores the user by storing the specific ID, the public ID, the user public ID, and the registration address in correspondence. In the temporary user registration, service server 2 sets correspondence between the log-in ID and the password, and stores the log-in ID and the password in a corresponding relationship to the specific ID, the public ID, the registration address, and the user public information.

In the temporary user registration, service server 2 can identify the user of terminal 1 by using the specific ID. When the extracted specific ID and the extracted pubic ID have been stored in correspondence, service server 2 can notify terminal 1 of rejection of the user registration request. Then, in step 511, after having temporarily registered the user, service server 2 transmits a temporary user registration notification to contact device 4 by designating the registration address received from terminal 1 as an address. The temporary user registration notification can contain a message indicating that the user has temporarily been registered, the log-in ID, and the password.

In step 512, contact device 4 transfers the temporary user registration notification transmitted from service server 2 by designating the registration address to terminal 1 by designating the unique ID of terminal 1 stored in the corresponding relationship to the registration address as an address.

Then, in step 513, terminal 1 receives the temporary user registration notification from contact device 4.

Subsequently, in step 514, terminal 1 transmits a confirmation notification indicating that the temporary user registration notification has been confirmed to service server 2. Service server 2 receives the confirmation notification from terminal 1.

In step 515, service server 2 registers the user. In the exemplary embodiment, service server 2 sets the pubic ID, and the user public information to which the public ID has been provided to be openable to the outside, and can accordingly provide services to the user.

After having registered the user, service server 2 transmits information on a user registration completion notification screen indicating that the user has been registered to terminal 1. Then, when the log-in ID and the password contained in the temporary registration notification arrives from terminal 1, service server 2 compares correspondence between the log-in ID and the password transmitted from terminal 1 with correspondence between the log-in ID and the password stored in the service server. When both match each other, as shown in FIG. 13, service server 2 displays the user public information and the public ID regarding the user of terminal 1.

The operational sequence according to the best mode of the present invention has been described.

As described above, according to the exemplary embodiment, the public ID is generated by using the unique ID provided beforehand to one specific user and the personal ID arbitrarily set by the user. Hence, the same public ID is issued, even between difference servers, to the same personal ID used by the same user.

Thus, even when the personal ID is used for a plurality of service servers, a third party can identify the user. In other words, service server 2 can identify the user, and the third party can understand that an owner of the same public ID opened by the plurality of service servers is the same person. There is no need to open the personal ID or the unique ID. As a result, an account owner in the service server can be opened to the outside without revealing any personal information.

According to the exemplary embodiment, even when others steal the specific ID, illegal use of the specific ID can be prevented. A reason is that services can be used after the temporary user registration is transmitted during use of the specific ID and after the confirmation notification is received.

According to the exemplary embodiment, when the temporary registration notification is transmitted, the temporary registration notification is automatically transmitted from service server 2 to contact device 3. This allows the user to manage only the unique ID without managing the specific ID (more specifically, registration address). As a result, loads when the user manages contact destinations can be reduced.

The exemplary embodiments of the present invention have been described. However, the present invention is not limited to the exemplary embodiments. Various changes understandable to those skilled in the art can be made of the configuration and the operation of the present invention without departing from the spirit and scope of the invention.

For example, account server 3 can have the functions of contact device 4. In this case, as shown in FIG. 7, account server 3 can be configured to include the components (user information reception unit 4A and others) of contact device 4.

This application claims priority from Japanese Patent Application No. 2009-27270 filed Feb. 9, 2009, which is hereby incorporated by reference herein in its entirety.

1. An account issuance system comprising:
a terminal used by a user;
a service server that provides services to the user via the terminal; and
an account server that issues an account used by the service sever to identify the user,
wherein:
the terminal transmits joint identification information of the user set by the user to the account server and, after having received a public ID used by a third party different from the user to identify the user from the account server, transfers the public ID to the service server;
the account server stores a unique ID to uniquely identify the user, generates, after having received the joint identification information from the terminal, the public ID by using the joint identification information and the unique ID, and transmits the public ID to the terminal; and
the service server sets, after having received the public ID from the terminal, the public ID to be openable to the outside.

2. The account issuance system according to claim 1, wherein the account server generates the public ID by applying a predetermined hash function to data containing the joint identification information and the unique ID.

3. The account issuance system according to claim 1, further comprising a contact device connectable to the account server, the service server, and the terminal, wherein:
the unique ID designates the terminal as an address;
the account server, after having received a service ID to identify the service server together with the joint identification information from the terminal, generates a specific ID used by the service server to identify the user by using the service ID and the unique ID, transmits the specific ID together with the public ID to the terminal, and transmits the specific ID and the unique ID to the contact device;
the terminal transmits the service ID together with the joint identification information to the account server, transfers, after having received the specific ID and the public ID from the account server, the specific ID and the public ID to the service server, and transmits, after having received a temporary user registration notification indicating that the user has temporarily been registered from the contact device, a confirmation notification indicating that the temporary user registration notification has been confirmed to the service server;
the service server adds the specific ID to the temporary user registration notification to transmit the notification to the contact device after having received the pubic ID and the specific ID from the terminal, and sets the public ID to be openable to the outside after having received the conformation notification from the terminal; and
the contact device stores, after having received the specific ID and the unique ID from the account server, the specific ID and the unique ID in correspondence, and transfers, after having received the temporary user registration notification from the service server, the temporary user registration notification to the terminal designated by the unique ID corresponding to the specific ID added to the temporary user registration notification.

4. The account issuance system according to claim 3, wherein the account server generates the specific ID by applying a predetermined hash function to data containing the unique ID and the service ID.

5. An account server that issues an account used by a service server for providing services to a user of a terminal via the terminal to identify the user, comprising:
a storage unit that stores a unique ID to uniquely identify the user;
a reception unit that receives joint identification information of the user set by the user from the terminal; and
an ID generation unit that generates, by using the joint identification information received by the reception unit and the unique ID stored by the storage unit, a public ID used by a third party different from the user to identify the user, and transmits the public ID to the terminal.

6. The account server according to claim 5, wherein the ID generation unit generates the public ID by applying a predetermined hash function to data containing the joint identification information and the unique ID.

7. The account server according to claim 5, further comprising a user information transmission unit, wherein:
the unique ID designates the terminal as an address;
the reception unit receives a service ID to identify the service server together with the joint identification information;
the ID generation unit generates a specific ID used by the service server to identify the user by using the service ID received by the reception unit and the unique ID stored by the storage unit; and
the user information transmission unit transmits the specific ID generated by the ID generation unit and the unique ID stored by the storage unit to a contact device configured to transfer data having the specific ID added thereto to the terminal designated by the unique ID.

8. The account server according to claim 7, wherein the ID generation unit generates the specific ID by applying a predetermined hash function to data containing the unique ID and the service ID.

9. (canceled)

10. An account issuance method based on an account issuance system,
the account issuance system including a terminal used by a user, a service server that provides services to the user via the terminal, and an account server that issues an account used by the service sever to identify the user, the account server being configured to store a unique ID to uniquely identify the user,
the method comprising:
transmitting joint identification information of the user set by the user to the account server by the terminal;
generating, by the account server, after having received the joint identification information from the terminal, a public ID used by a third party different from the user to identify the user by using the joint identification information and the unique ID, and transmitting the public ID to the terminal;
transmitting, after having received the public ID from the account server, the public ID to the service server by the terminal; and
setting, after having received the public ID from the terminal, the public ID to be openable to the outside by the service server.

11. The account issuance method according to claim 10, wherein the account server generates the public ID by applying a predetermined hash function to data containing the joint identification information and the unique ID.

12. The account issuance method according to claim 10,
the account issuance system further including a contact device connectable to the account server, the service server, and the terminal, wherein:
the unique ID designates the terminal as an address;
the terminal transmits a service ID to identify the service server together with the joint identification information to the account server,
the account server receives the service ID together with the joint identification information from the terminal, and generates a specific ID used by the service server to identify the user by using the joint identification information and the stored unique ID;
the account server transmits the specific ID and the unique ID to the contact device;
the account server transmits the specific ID together with the public ID to the terminal;
the contact device receives the specific ID and the unique ID from the account server, and stores the specific ID and the unique ID in correspondence;
the terminal receives the specific ID and the public ID from the account server, and transfers the specific ID and the public ID to the service server;
the service server receives the public ID and the specific ID from the terminal;
the service server adds the specific ID to a temporary user registration notification indicating that the user has temporarily been registered to transmit the notification to the contact device;
the contact device transfers, after having received the temporary user registration notification from the service server, the notification to the terminal designated by the unique ID corresponding to the specific ID added to the temporary user registration notification;
the terminal transmits, after having received the temporary user registration notification from the contact device, a confirmation notification indicating that the temporary user registration notification has been confirmed, to the service server; and
the service server sets, after having received the confirmation notification from the terminal, the stored public ID to be openable to the outside.

13. The account issuance method according to claim 12, wherein the account server generates the specific ID by applying a predetermined hash function to data containing the unique ID and the service ID.

14-18. (canceled)
